(19) United States
(12) Patent Application Publication
(10) Pub. No.: US 2024/0062059 A1
(43) Pub. Date: Feb. 22, 2024

(54) NEURAL NETWORK LAYER OPTIMIZATION

(71) Applicant: TEXAS INSTRUMENTS INCORPORATED, Dallas, TX (US)

(72) Inventors: Manu Mathew, Dallas, TX (US); Anand Pathak, Dallas, TX (US); Anshu Jain, Dallas, TX (US); Kumar Desappan, Dallas, TX (US)

(21) Appl. No.: 18/191,700

(22) Filed: Mar. 28, 2023

(30) Foreign Application Priority Data
Aug. 22, 2022 (IN) 202241047830

(51) Int. Cl. G06N 3/08

(52) U.S. Cl. CPC G06N 3/08

(57) ABSTRACT

Various examples disclosed herein relate to neural network quantization techniques, and more particularly, to selecting inference precisions for the layers of the neural network. In an example embodiment, a method is provided herein that includes determining an accuracy improvement of a layer of a neural network implemented using a first bit precision relative to using a second bit precision and determining a latency degradation of the layer of the neural network implemented using the first bit precision relative to using the second bit precision. The method further includes selecting, based on the accuracy improvement and the latency degradation, the first bit precision or the second bit precision for use in implementing the layer of the neural network.

### RELATED APPLICATIONS

This application hereby claims the benefit and priority to India Provisional Patent Application No. 202241047830, titled “AUTOMATIC MIXED PRECISION QUANTIZATION FOR DEEP NEURAL NETWORKS,” filed Aug. 22, 2022, which is hereby incorporated in its entirety.

### TECHNICAL FIELD

This relates generally to neural network quantization techniques, and more particularly, to selecting computation precision for layers of a neural network.

### BACKGROUND

Neural networks are used to solve various Artificial Intelligence (AI) tasks, such as image recognition (e.g., image classification, object detection, segmentation), natural language processing, anomaly detection, and driving applications, among others. To do so, neural networks must be trained with vast amounts of sample data. Following a training phase, neural networks can be deployed to perform inferences on test inputs to predict outputs based on the test inputs. When performing deployment inferences, neural networks often use low precision computations as opposed to floating point computations (e.g., 32-bit float), especially when operating in constrained environments (e.g., embedded systems), given bandwidth, power, cost, and performance constraints. Examples of low precision computations include 4-bit integer, 8-bit integer, 16-bit integer, and 16-bit float. 8-bit integer computations are most frequently used because such computations conserve the most energy and provide the best inference speed with good accuracy, among low precision computation types.

Unlike the deployment mode when neural networks implement low precision computations to perform test inferences, training mode often utilizes floating point computations to produce the most accurate results. Thus, when neural networks transition from the training mode to the deployment mode, the layers of the neural networks must be quantized so that the neural networks can be executed using 8-bit integer computations. Quantization refers to the process of converting data and parameters of layers of a neural network from one bit precision to another bit precision. Problematically, quantization can cause outputs produced in a lower bit precision to deviate from outputs produced in higher precision (i.e., during training mode). These deviations are often referred to as quantization error.

Traditional methods of reducing quantization error in neural networks include post-training quantization (PTQ) and quantization aware training (QAT). However, such solutions fail to reduce substantial quantization error and can result in high accuracy degradation, especially when the neural networks are poorly trained, difficult to quantize, or produce regression outputs.

### SUMMARY

Disclosed herein are improvements to neural network quantization techniques. Quantization, in the neural network context, refers to converting data and parameters (e.g., weights, bias) of layers of a neural network from one bit precision to another bit precision (e.g., 32-bit to 8-bit). For example, a neural network trained with full precision, or using 32-bit floating point computations, may require quantization to reduce the precision of the computations to reduce the memory required to execute the neural network. Often, such quantization is required because operating a neural network with full precision requires significant memory and time, which may not be available for an embedded system, for example. Alternatively, however, operating a neural network at low precision, or using 8-bit fixed point computations, can increase execution speed but lead to inaccurate results. Instead, quantization techniques described here can introduce mixed precision computations, which may allow layers of a neural network to be implemented using various bit precisions to balance accuracy and execution speed.

In an example embodiment, a method is provided herein that includes determining an accuracy improvement of a layer of a neural network implemented using a first bit precision relative to using a second bit precision and determining a latency degradation of the layer of the neural network implemented using the first bit precision relative to using the second bit precision. The method further includes selecting, based on the accuracy improvement and the latency degradation, the first bit precision or the second bit precision for use in implementing the layer of the neural network.

This Summary is provided to introduce a selection of concepts in a simplified form that are further described below in the Detailed Description. It may be understood that this Summary is not intended to identify key features or essential features of the claimed subject matter, nor is it intended to be used to limit the scope of the claimed subject matter.

### BRIEF DESCRIPTION OF THE DRAWINGS

FIG. 1 illustrates an example operating environment configurable to perform neural network layer configuration processes in an implementation.

FIG. 2 illustrates a series of steps for selecting a bit precision of a layer of a neural network in an implementation.

FIG. 3 illustrates an example operating environment for executing a neural network configured using layer configuration processes in an implementation.

FIG. 4 illustrates a series of steps for configuring layers of a neural network in a mixed precision mode.

FIG. 5 illustrates example neural networks and layer configuration thereof in an embodiment.

FIG. 6 illustrates a computing device that may be used in accordance with some examples of the present technology.

The drawings are not necessarily drawn to scale. In the drawings, like reference numerals designate corresponding parts throughout the several views. In some examples, components or operations may be separated into different blocks or may be combined into a single block.

### DETAILED DESCRIPTION

Discussed herein are enhanced components, techniques, and systems related to neural network quantization and configuration of layers of neural networks using different precision computations. Quantization refers to the process of converting data and parameters of a layer of a neural network from one bit precision (e.g., size, bit length, and/or resolution) to another precision. Often times, a neural network, and layers thereof, are trained using parameters, such as weights, in a floating point mode, which can provide the best accuracy with respect to results of inferences of the neural network. However, the neural network, and layers thereof, are generally executed during runtime using parameters in a fixed point mode to increase execution speed and reduce memory requirements. Consequently, there are trade-offs for configuring the layers of a neural network to use one type of bit precision or another (e.g., fixed point or floating point).

A configuration engine, such as one described herein, can analyze how layers of a neural network perform using different levels of bit precision. For example, the configuration engine can execute the layers in the floating point mode, a first bit precision mode, and in a second bit precision mode. Then, the configuration engine can compare accuracy improvement and latency degradation among the different modes to a threshold value. Based on the accuracy improvement and latency degradation, the configuration engine can choose which one or more layers of the neural network to implement using one or more of the bit precisions. Advantageously, such techniques offer improved accuracy of a neural network inference while maintaining execution speed above a threshold.

One example embodiment includes a method. The method includes determining an accuracy improvement of a layer of a neural network implemented using a first bit precision relative to using a second bit precision and determining a latency degradation of the layer of the neural network implemented using the first bit precision relative to using the second bit precision. The method further includes selecting, based on the accuracy improvement and the latency degradation, the first bit precision or the second bit precision for use in implementing the layer of the neural network.

In another example, a configuration engine is provided. The configuration engine includes one or more computer-readable storage media, a processing system coupled to the one or more computer-readable storage media, and program instructions stored on the one or more computer-readable storage media that, based on being read and executed by the processing system, direct the configuration engine to perform various functions. For example, the program instructions can direct the configuration engine to determine an accuracy improvement of a layer of a neural network implemented using a first bit precision relative to using a second bit precision. The program instructions can also direct the configuration engine to determine a latency degradation of the layer of the neural network implemented using the first bit precision relative to using the second bit precision. The program instructions can further direct the configuration engine to select, based on the accuracy improvement and the latency degradation, the first bit precision or the second bit precision for use in implementing the layer of the neural network.

In yet another embodiment, one or more computer-readable storage media having program instructions stored thereon, wherein the program instructions, when read and executed by a processing system, direct the processing system to determine an accuracy improvement of a layer of a neural network implemented using a first bit precision relative to using a second bit precision, determine a latency degradation of the layer of the neural network implemented using the first bit precision relative to using the second bit precision, and select, based on the accuracy improvement and the latency degradation, the first bit precision or the second bit precision for use in implementing the layer of the neural network.

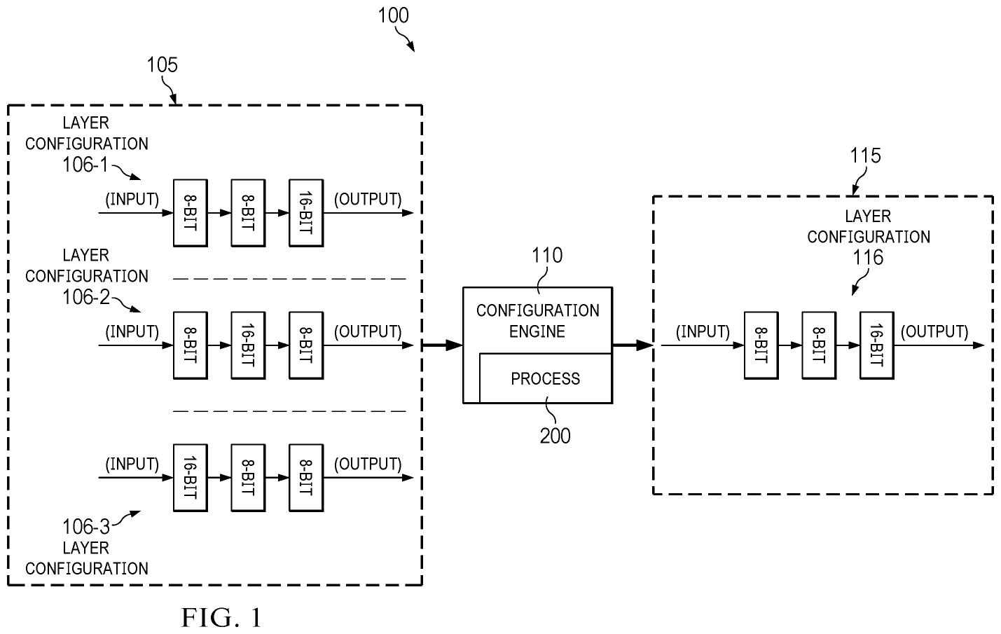

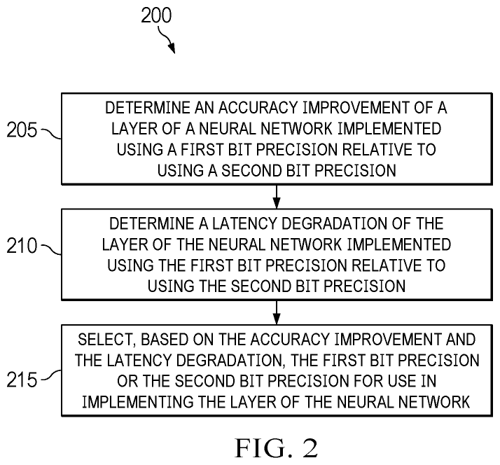

FIG. 1 illustrates an example operating environment configurable to perform neural network layer configuration processes in an implementation. FIG. 1 shows operating environment 100, which includes neural network data 105, configuration engine 110, and neural network configuration 115. Configuration engine 110 can be configured to operate neural network layer configuration processes, such as process 200 of FIG. 2, to determine quantization for layers of a neural network.

Neural network data 105 is representative of information corresponding to a neural network and executions thereof. For example, neural network data 105 may include performance data (e.g., accuracy metrics, latency metrics) related to executions of the neural network using combinations and variations of layers implemented with different bit precisions (e.g., floating point bit precision, fixed point bit precision). In other words, the layers of the neural network may be configured using different levels of bit precision, via quantization, and data related to the execution thereof can be identified. Floating point bit precision may refer to using 32-bit floating data, while fixed point bit precision may refer to using 4-bit integer data, 8-bit integer data, 16-bit integer data, or any other data having a length of a fixed integer.

In various examples, neural network data 105 also includes data of test executions of the neural network, which can be performed to obtain baseline metrics related to accuracy and latency of the neural network. This may entail executing the neural network using floating point computations at each of the layers, then executing the neural network using 8-bit computations at each of the layers. The baseline metrics thus indicate how accurate each layer of the neural network is when using 8-bit precision relative to using floating point computations and how fast each layer of the network is at performing an inference when using 8-bit precision relative to using floating point computations.

After obtaining baseline metrics corresponding to different executions of the neural network, layers of the neural network can be configured to use combinations of different bit precisions. Examples of combinations, or configurations, may include layer configurations 106-1, 106-2, and 106-3 (collectively referred to herein as layer configurations 106). Layer configurations 106 demonstrate a neural network having three layers. In layer configuration 106-1, the first and second layers are configured to use 8-bit precision, and the third layer is configured to use 16-bit precision. In layer configuration 106-2, the first and third layers are configured to use 8-bit precision, and the second layer is configured to use 16-bit precision. In layer configuration 106-3, the first layer is configured to use 16-bit precision, and the second and third layers are configured to use 8-bit precision. The neural network, in each configuration, can ingest input data, performs computations at each layer with respective levels of precision, and produce an output. The speed and accuracy at which the neural network produces the output, however, may vary based on the respective one of layer configurations 106.

Configuration engine 110 is representative of a computing device or processing system capable of obtaining neural network data 105, comparing performance data corresponding to each of layer configurations 106-1, 106-2, and 106-3, and selecting layer configuration 116 based on neural network data 105.

In operation, configuration engine 110 can identify an accuracy metric of each layer of the neural network using 16-bit precision, an accuracy metric of each layer using 8-bit precision, a latency metric of each layer using 16-bit precision, and a latency metric of each layer using 8-bit precision. Configuration engine 110 can compare the accuracy metrics to each other to determine an accuracy improvement of a layer implemented using 16-bit precision relative to using 8-bit precision. Configuration engine 110 can also compare the latency metrics to each other to determine a latency degradation of a layer implemented using 16-bit precision relative to using 8-bit precision.

Next, configuration engine 110 can compare the accuracy improvement of a layer to the latency degradation of a layer. The result of the comparison between the accuracy improvement and the latency degradation is referred to herein as the impact factor of a layer. Configuration engine 110 may sort the impact factors of each layer in order from greatest to least (i.e., best accuracy improvement over least latency degradation). From the impact factors, configuration engine 110 can select the configuration of layer configurations 106 that derives the best impact factor and produce neural network configuration 115 having layer configuration 116. In this example, layer configuration 116 includes the first and second layers using 8-bit precision and the third layer using 16-bit precision. However, other combinations and variations of layers and bit precisions can be contemplated for neural network configuration 115. Configuration engine 110 can then provide neural network configuration 115 to one or more downstream devices, such as microcontroller units (MCUs) or other embedded systems capable of executing a neural network with quantization of layers according to layer configuration 116.

In other examples, configuration engine 110 may further analyze additional combinations and variations of layer configurations. For example, layer configurations may include neural networks with more than one layer using 16-bit precision, or any other type of bit precision.

FIG. 2 illustrates a series of steps for selecting a bit precision of a layer of a neural network in an implementation. FIG. 2 includes process 200 described parenthetically below, which references elements of FIG. 1. Process 200 can be implemented on software, firmware, or hardware, or any combination or variation thereof. For example, a configuration engine, such as configuration engine 110 of operating environment 100 of FIG. 1, can perform process 200.

In operation 205, configuration engine 110 determines (205) an accuracy improvement of a layer of a neural network implemented using a first bit precision relative to using a second bit precision. A neural network described herein can include a plurality of layers. Each layer may ingest inputs, perform computations on the inputs, and produce outputs, which can be fed to another layer. Parameters of each layer, such as weights and biases, denote a level of precision of such computations. Often, neural networks are trained using floating point data (i.e., 32-bit precision) to train the layers to output results with high accuracy, but for runtime operations, the parameters may be quantized from floating point precision to either the first bit precision or the second bit precision. The first bit precision may refer to 16-bit precision, and the second bit precision may refer to 8-bit precision, however, the level of precision may include any other level of precision having either a length of a fixed integer (e.g., 4-bit precision) or having a floating length (e.g., 16-bit float).

To determine the accuracy improvement of the layer, configuration engine 110 can first identify an accuracy metric of the layer of the neural network using 16-bit precision (i.e., the first bit precision) and an accuracy metric of the layer using 8-bit precision (i.e., the second bit precision). Then, configuration engine 110 can compare the delta between the accuracy metrics to determine whether the output produced by the layer using 16-bit precision is more or less accurate than the output produced by the layer using 8-bit precision.

Next, in operation 210, configuration engine 110 determines (210) a latency degradation of the layer of the neural network implemented using the first bit precision relative to using the second bit precision. Similar to operation 205, to determine the latency degradation of the layer, configuration engine 110 can first identify a latency metric of the layer using 16-bit precision, and a latency metric of the layer using 8-bit precision. Then, configuration engine 110 can compare the delta between the latency metrics to determine whether the output produced by the layer using 16-bit precision is faster or slower than the output produced by the layer using 8-bit precision.

Lastly, in operation 215, configuration engine 110 selects (215) either the first bit precision or the second bit precision for use in implementing the layer of the neural network based on the accuracy improvement and the latency degradation determined in operations 205 and 210, respectively. Configuration engine 110 may perform these operations for each layer of the neural network to determine which combination of layers using either 16-bit precision or 8-bit precision provides the highest accuracy improvement and the smallest latency degradation with respect to each other. The result of the comparison between the accuracy improvement and the latency degradation of a layer is referred to herein as the impact factor of a layer. Configuration engine 110 may sort the impact factors of each layer in order from greatest to least. From the impact factors, configuration engine 110 can select the configuration of layer configurations 106 that derives the best impact factor. As illustrated in FIG. 1, configuration engine 110 produces neural network configuration 115 having layer configuration 116 from such comparisons. Configuration engine 110 can provide neural network configuration 115 to one or more downstream devices, such as microcontroller units (MCUs) or other embedded systems capable of executing a neural network with quantization of layers according to layer configuration 116.

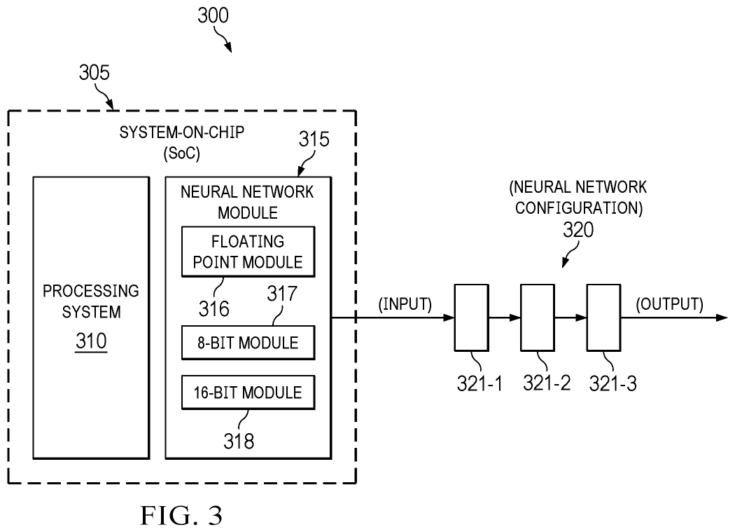

FIG. 3 illustrates an example operating environment for executing a neural network configured using layer configuration processes in an implementation. FIG. 3 shows operating environment 300, which includes system-on-chip (SoC) 305 and components thereof. SoC 305 includes processing system 310 and neural network module 315, which further includes elements to perform neural network operations according to neural network configuration 320. In various examples, SoC 305 can execute a neural network configured by a configuration engine, such as configuration engine 110 of FIG. 1.

SoC 305 is representative of an embedded system configured to predict outputs using a neural network based on inputs to SoC 305. For example, SoC 305 may represent a microcontroller unit (MCU) of a system, such as in an image detection system or a language processing system, among other environments. SoC 305 may also represent a test platform for performing operations, and obtaining results thereof, using a neural network according to a configuration. SoC 305 includes processing system 310 and neural network module 315, among other components (not shown), to perform such tasks.

Processing system 310 is representative of any one or more processors (e.g., a central processing unit) capable of executing program instructions to perform neural network processes. To perform inferences using a neural network, processing system 310 can execute neural network computations from neural network module 315. For example, processing system 310 can utilize neural network module 315 as a hardware accelerator (HWA).

Neural network module 315 includes floating point module 316, 8-bit module 317, and 16-bit module 318. In some cases, each module of neural network module 315 functions as an individual HWA. However, in other cases, the modules of neural network module 315 function as a single, integrated HWA. Floating point module 316 can perform computations using floating point data, 8-bit module 317 can perform computations using 8-bit precision, and 16-bit module 318 can perform computations using 16-bit precision. In various examples, such as during runtime operations of SoC 305, SoC 305 may lack computing resources or bandwidth to perform computations of a neural network with high precision (i.e., using 32-bit floating point data). Therefore, SoC 305 may utilize one or more fixed point modules (8-bit module 317 or 16-bit module 318) of neural network modules 315 to perform inferences at various layers of the neural network using different levels of precision.

In operation, a configuration engine (e.g., configuration engine 110 of FIG. 1) may provide neural network configuration 320 to SoC 305. Neural network configuration 320 includes layers 321-1, 321-2, and 321-3 (collectively referred to as layers 321), each of which can perform inferences using input data. Layers 321 can use floating point data, fixed point data (e.g., a level of bit precision having an integer length), or any combination or variation thereof to perform inferences. In one example, layer 321-1 and layer 321-2 may use 8-bit precision, and layer 321-3 may use 16-bit precision. Accordingly, processing system 310, when executing operations using the neural network according to neural network configuration 320, may use 8-bit module 317 to perform computations of layer 321-1 and layer 321-2, and processing system 310 may use 16-bit module 318 to perform computations of layer 321-3.

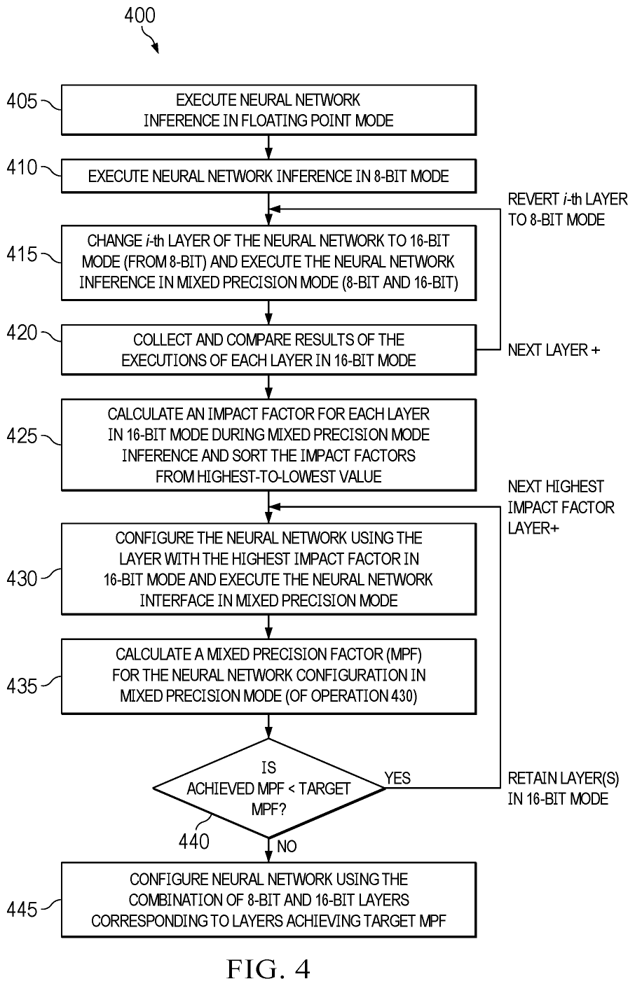

FIG. 4 illustrates a series of steps for configuring layers of a neural network in a mixed precision mode. FIG. 4 includes process 400 described parenthetically below, which references elements of FIG. 1. Process 400 can be implemented on software, firmware, or hardware, or any combination or variation thereof. For example, a configuration engine, such as configuration engine 110 of operating environment 100 of FIG. 1, can perform process 400.

To begin, in operation 405, configuration engine 110 executes (405) a neural network inference in floating point mode. A neural network inference refers to computations performable by the layers of a neural network to produce an output. Neural network inferences can be performed in a fixed point mode, using one or more types of fixed point data, or in a floating point mode, using floating point data. Floating point data may refer to 32-bit floating data, while fixed point data may refer to 8-bit integer data, 16-bit integer data, or any other data having a length of a fixed integer. By executing the neural network inference in floating point mode, configuration engine 110 can obtain metrics related to accuracy and speed of the neural network inference in floating point mode.

In operation 410, configuration engine 110 executes (410) the neural network inference in 8-bit mode. To do so, configuration engine 110 can quantize the parameters and data of the layers of the neural network from floating point data to fixed point data. By executing the neural network inference in 8-bit mode, configuration engine 110 can obtain metrics related to accuracy and speed of the neural network inference in 8-bit mode.

Next, in operation 415, configuration engine 110 changes (415) a first layer (e.g., the i-th layer) of the neural network from 8-bit mode to 16-bit mode and executes the neural network in a mixed precision mode (i.e., a combination of layers using data of different precision). In this first configuration, for a neural network with three layers, for example, the first layer uses 16-bit fixed point data and the second and third layers use 8-bit fixed point data to perform the neural network inference. Then, configuration engine 110 can repeat this operation and revert the first layer of the neural network to 8-bit mode, then change the second layer of the neural network to 16-bit mode. In this second configuration, the first and third layers use 8-bit fixed point data, and the second layer uses 16-bit fixed point data to perform the neural network inference. Then, configuration engine 110 can revert the second layer back to 8-bit mode and change the third layer to 16-bit mode. In this third configuration, the first and third layers use 8-bit fixed point data, and the third layer uses 16-bit fixed point data. Configuration engine 110 can repeat operation 415 for any number of layers to account for all combinations and variations of layers in 8-bit mode and one layer at a time in 16-bit mode.

In operation 420, configuration engine 110 collects and compares (420) results of the execution of the neural network inferences in mixed precision mode. Configuration engine 110 can identify an accuracy metric for each layer of the neural network using 16-bit fixed point data, an accuracy metric for each layer using 8-bit fixed point data, a latency metric for each layer using 16-bit fixed point data, and a latency metric for each layer using 8-bit fixed point data. Configuration engine 110 can compare the accuracy metrics to each other to determine an accuracy improvement of a layer implemented using 16-bit fixed point data relative to using 8-bit fixed point data. Configuration engine 110 can also compare the latency metrics to each other to determine a latency degradation of a layer implemented using 16-bit fixed point data relative to using 8-bit fixed point data.

Next, in operation 425, configuration engine 110 calculates (425) an impact factor for each layer while in 16-bit mode. The impact factor may indicate an importance of a layer to the inference of the neural network. In various examples, the impact factor is based on the comparison between the accuracy improvement and the latency degradation of a layer using 16-bit precision relative to using 8-bit precision. Configuration engine 110 may first calculate a quantization error of the neural network inference in 8-bit mode relative to the neural network inference in floating point mode (e.g., 32-bit floating point data). This 8-bit quantization error (E_{8-bit}) can be defined using the following equation, where “D” is a distance between two tensors of a layer (e.g., a pre-determined layer in the neural network) and “Y” is the output of the inference:

E_{8-bit}=D(Y_{8-bit},Y_{32-bit})

Configuration engine 110 also calculates a quantization error for each mixed precision mode configuration. In other words, configuration engine 110 determines a quantization error for the neural network inferences with the i-th layer in 16-bit mode and the other layers in 8-bit mode relative to the neural network inference in floating point mode. This mixed precision mode quantization error (Emi) can be defined using the following equation:

Eₘᵢ=D(Yₘᵢ,Y₃₂).

Both the 8-bit quantization error and the mixed precision mode quantization error can represent an accuracy improvement or degradation of a neural network inference based on the configuration of the layers. Then, configuration engine 110 can compare the quantization errors calculated above with the latency degradation of the neural network inference using the i-th layer in 16-bit mode relative to using 8-bit mode. Thus, the impact factor can be defined using the following equation, where “Tim” is the inference time for a neural network inference with the i-th layer in 16-bit mode and the other layers in 8-bit mode and “Ts” is the inference time for a neural network inference with all layers in 8-bit mode:

Impact factor=(E₈−Eₘᵢ)/(Tₘᵢ−T₈).

Configuration engine 110 can calculate an impact factor for each layer. Following the previous example where the neural network includes three layers, configuration engine 110 can calculate three impact factors associated with the three layers using 16-bit precision (i.e., in 16-bit mode). Configuration engine 110 can sort the impact factors from highest-to-lowest value.

In operation 430, configuration engine 110 configures (430) the neural network to use the layer with the highest impact factor in 16-bit mode and executes the neural network inference in mixed precision mode. Following the previous example where the neural network includes three layers, configuration engine 100 may determine that the first layer has the highest impact factor among the three layers. Accordingly, configuration engine 110 can choose the configuration in which the first layer uses 16-bit precision and the second and third layers use 8-bit precision. As a result of the neural network inference in this configuration, configuration engine 110 can calculate (435) a mixed precision factor (“MPF”) for the neural network configuration in mixed precision mode. The MPF is based on a ratio between the time it takes to perform a neural network inference in mixed precision mode and the time it takes to perform the neural network inference in 8-bit mode. The MPF can be defined using the following equation:

MPF=Tₘᵢ/T₈.

Next, in operation 440, configuration engine 110 compares (440) the MPF to a target MPF for the neural network. The target MPF may be a user-defined threshold value or a pre-configured threshold value based on various factors, such as the processing capacity and capability of a processing system (e.g., processing system 310 of FIG. 3) configured to execute the neural network inference. If the MPF associated with a layer configuration does not exceed the target MPF, configuration engine 110 can repeat operations 430, 435, and 440 to create a layer configuration with multiple layers using 16-bit precision. When repeating operation 430, configuration engine 110 can identify the layer with the next highest impact factor among the impact factors. Configuration engine 110 can retain the layer previously implemented using 16-bit precision (i.e., the layer having the highest impact factor (the first layer in the previous example)) and also implement the layer with the next highest impact factor using 16-bit precision. Then, configuration engine 110 can calculate the MPF for this neural network configuration and compare the MPF to the target MPF. If this MPF still does not exceed the target MPF, configuration engine 110 can repeat operations 430, 435, and 440 again.

If, however, configuration engine 110 determines that a MPF (either the first MPF or a subsequent MPF) exceeds the target MPF, configuration engine 110 can configure (445) the neural network using the combination of layers with 8-bit and 16-bit precision determined before exceeding the target MPF. In other words, configuration engine 110 can revert a layer changed in a repeated operation 430 such that the chosen combination of layers does not exceed the target MPF. By way of example, configuration engine 110 can calculate a first MPF for a first configuration where the first layer uses 16-bit precision and the second and third layers use 8-bit precision. Configuration engine 110 can determine that the first MPF does not exceed the target MPF, so configuration engine 110 can change the second layer (i.e., the layer with the next highest impact factor, for example) to 16-bit mode. Then, configuration engine 110 can calculate a second MPF for this second configuration where the first and second layer use 16-bit precision and third layer uses 8-bit precision. Configuration engine 110 may determine that the second MPF does not exceed the target MPF, so configuration engine 110 can change the third layer (i.e., the layer with the next highest impact factor after the two other highest impact factors) to 16-bit mode. Configuration engine 110 can calculate a third MPF for this third configuration where all layers use 16-bit precision. However, configuration engine 110 can determine that the third MPF exceeds the target MPF. Accordingly, configuration engine 110 can revert to the second configuration in operation 445 as the second configuration produced the MPF immediately prior to the MPF that breached the threshold.

Additionally or alternatively, configuration engine 110 can stop repeating operations 430, 435, and 440 once all layers have been changed to 16-bit mode and the MPF of the configuration where all layers use 16-bit precision does not exceed the target MPF. However, in other cases, configuration engine 110 may also stop repeating operations 430, 435, and 440 to avoid changing all layers of the neural network to 16-bit mode.

Additionally or alternatively, configuration engine 110 may configure the neural network with a combination of layers in 8-bit and 16-bit mode that exceeds the target MPF. In such cases, a second threshold value greater than the target MPF can be introduced. Configuration engine 110 can use the second threshold value to determine whether a MPF exceeds the target MPF by an excessive amount, or in other words, also exceeds the second threshold value.

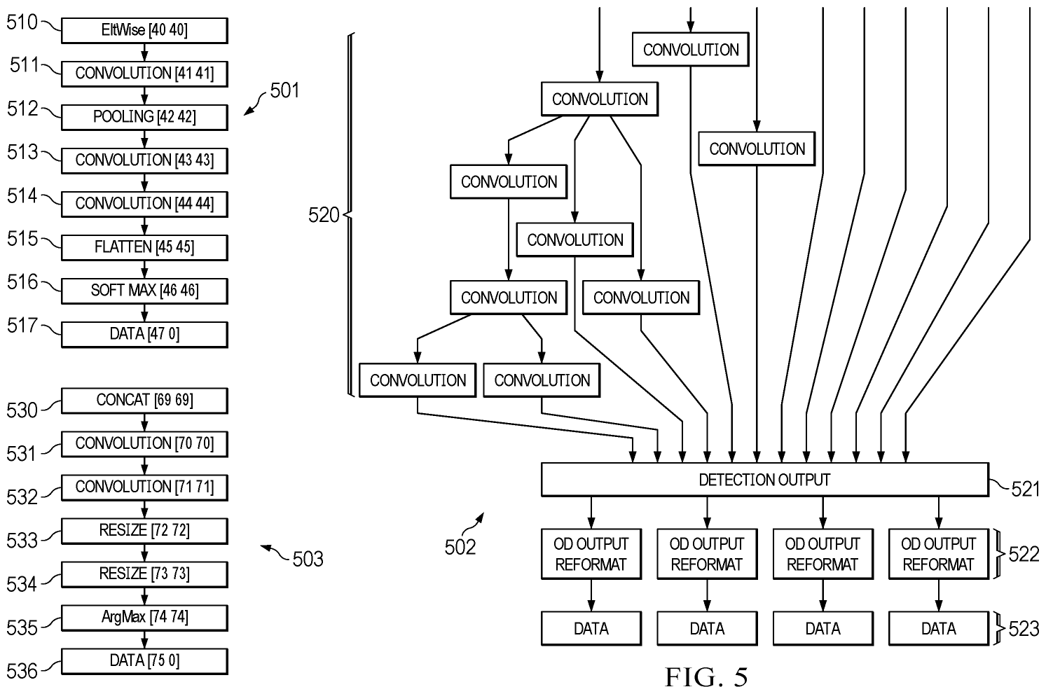

FIG. 5 illustrates example neural networks and layer configurations thereof in an embodiment. FIG. 5 includes classification neural network 501, object detection neural network 502, and segmentation neural network 503. In various examples, a configuration engine (e.g., configuration engine 110 of FIG. 1) can determine layer configurations having mixed precision of the illustrated neural networks, such as by executing neural network configuration processes like process 200 of FIG. 2 or process 400 of FIG. 4.

As described in the discussion of FIG. 4, “D,” or the distance between tensors, is an important metric to determine the impact factor of a layer of a neural network using 16-bit fixed point data relative to using 8-bit fixed point data, or any combination or variation of fixed point and floating point data. In various examples, a configuration engine may use normalized mean average error (MAE) or normalized mean squared error (MSE) functions to calculate the distance metrics. To do so, the configuration engine may compute a mean and a standard deviation at each output of a neural network configured to run in floating point mode. The configuration engine can compute MAE/MSE errors on each output, add these errors to the mean and standard deviation of each output, and determine final MAE/MSE outputs for layer configuration purposes. Problematically, however, MAE and MSE functions may not produce reliable results for layers of neural networks that infer categorical outputs (e.g., object category ID). Instead of using layers that produce categorical outputs, the configuration engine can be configured to use other layers, such as preceding layers (with respect to ones producing categorical outputs) that feed inputs to layers that produce the categorical outputs.

Classification neural network 501, object detection neural network 502, and segmentation neural network 503 include example neural networks having layers that produce categorical outputs. Therefore, a configuration engine configured to determine a layer configuration for any similar neural network may identify a layer other than a categorical output layer and produce MAE/MSE outputs for layer configuration purposes using the other layer.

Referring first to classification neural network 501, classification neural network includes layers 510, 511, 512, 513, 514, 515, 516, and 517. Layer 516 represents a SoftMax layer that outputs a categorical output available at layer 517 (e.g., a classification). Accordingly, a configuration engine can use the input to layer 516, as opposed to the output of the neural network (i.e., the output of the final layer, layer 517), for distance and error calculations as discussed in the description related to FIG. 4.

Object detection neural network 502 includes layers 520, 521, 522, and 523. Layers 520 include convolution layers, layer 521 includes a detection layer, layers 522 include an output layer, and layers 523 include a reformatted output layer. Layer 521 outputs categorical outputs represented in layers 522. Accordingly, a configuration engine can use the input to layer 521 from the convolution operations to perform distance and error calculations as discussed in the description related to FIG. 4.

Segmentation neural network 503 includes layers 530, 531, 532, 533, 534, 535, and 536. Layer 535 represents an ArgMax layer that is used to identify a categorical output of segmentation neural network 503 available at layer 536. Therefore, a configuration engine can use the input to layer 535 to perform distance and error calculations as discussed in the description related to FIG. 4.

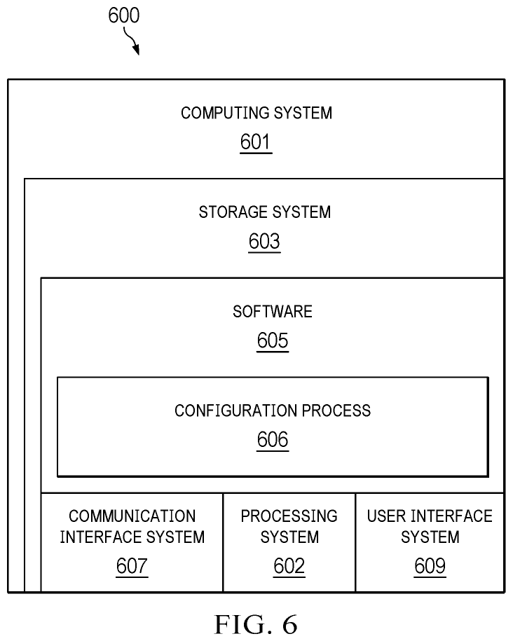

FIG. 6 illustrates computing system 601 configured to neural network layer configuration, according to an implementation of the present technology. Computing system 601 is representative of any system or collection of systems with which the various operational architectures, processes, scenarios, and sequences disclosed herein for neural network layer configuration may be employed. Computing system 601 may be implemented as a single apparatus, system, or device or may be implemented in a distributed manner as multiple apparatuses, systems, or devices. Computing system 601 includes, but is not limited to, processing system 602, storage system 603, software 605, communication interface system 607, and user interface system 609 (optional). Processing system 602 is operatively coupled with storage system 603, communication interface system 607, and user interface system 609. Computing system 601 may be representative of a cloud computing device, distributed computing device, or the like.

Processing system 602 loads and executes software 605 from storage system 603. Software 605 includes and implements configuration process 606, which is representative of any of the quantization, inference, and neural network layer configuration processes discussed with respect to the preceding Figures. When executed by processing system 602 to provide layer configuration functions, software 605 directs processing system 602 to operate as described herein for at least the various processes, operational scenarios, and sequences discussed in the foregoing implementations. Computing system 601 may optionally include additional devices, features, or functionality not discussed for purposes of brevity.

Referring still to FIG. 6, processing system 602 may comprise a micro-processor and other circuitry that retrieves and executes software 605 from storage system 603. Processing system 602 may be implemented within a single processing device but may also be distributed across multiple processing devices or sub-systems that cooperate in executing program instructions. Examples of processing system 602 include processing circuitry, such as any combination of general purpose central processing units, graphical processing units, application specific processors, field-programmable gate arrays, integrated circuitry, discrete logic circuitry, analog circuitry, and/or logic devices, as well as any other type of processing device, combinations, or variations thereof.

Storage system 603 may comprise any computer readable storage media readable by processing system 602 and capable of storing software 605. Storage system 603 may include volatile and nonvolatile, removable and non-removable media implemented in any method or technology for storage of information, such as computer readable instructions, data structures, program modules, or other data. Examples of storage media include random access memory, read only memory, magnetic disks, optical disks, optical media, flash memory, virtual memory and non-virtual memory, magnetic cassettes, magnetic tape, magnetic disk storage or other magnetic storage devices, or any other suitable storage media. In no case is the computer readable storage media a propagated signal.

In addition to computer readable storage media, in some implementations storage system 603 may also include computer readable communication media over which at least some of software 605 may be communicated internally or externally. Storage system 603 may be implemented as a single storage device but may also be implemented across multiple storage devices or sub-systems co-located or distributed relative to each other. Storage system 603 may comprise additional elements, such as a controller, capable of communicating with processing system 602 or possibly other systems.

Software 605 (including configuration process 606) may be implemented in program instructions and among other functions may, when executed by processing system 602, direct processing system 602 to operate as described with respect to the various operational scenarios, sequences, and processes illustrated herein. For example, software 605 may include program instructions for implementing a neural network configuration process as described herein.

In particular, the program instructions may include various components or modules that cooperate or otherwise interact to carry out the various processes and operational scenarios described herein. The various components or modules may be embodied in compiled or interpreted instructions, or in some other variation or combination of instructions. The various components or modules may be executed in a synchronous or asynchronous manner, serially or in parallel, in a single threaded environment or multi-threaded, or in accordance with any other suitable execution paradigm, variation, or combination thereof. Software 605 may include additional processes, programs, or components, such as operating system software, virtualization software, or other application software. Software 605 may also comprise firmware or some other form of machine-readable processing instructions executable by processing system 602.

In general, software 605 may, when loaded into processing system 602 and executed, transform a suitable apparatus, system, or device (of which computing system 601 is representative) overall from a general-purpose computing system into a special-purpose computing system customized to provide layer configuration as described herein. Indeed, encoding software 605 on storage system 603 may transform the physical structure of storage system 603. The specific transformation of the physical structure may depend on various factors in different implementations of this description. Examples of such factors may include, but are not limited to, the technology used to implement the storage media of storage system 603 and whether the computer-storage media are characterized as primary or secondary storage, as well as other factors.

For example, if the computer readable storage media are implemented as semiconductor-based memory, software 605 may transform the physical state of the semiconductor memory when the program instructions are encoded therein, such as by transforming the state of transistors, capacitors, or other discrete circuit elements constituting the semiconductor memory. A similar transformation may occur with respect to magnetic or optical media. Other transformations of physical media are possible without departing from the scope of the present description, with the foregoing examples provided only to facilitate the present discussion.

Communication interface system 607 may include communication connections and devices that allow for communication with other computing systems (not shown) over communication networks (not shown). Examples of connections and devices that together allow for inter-system communication may include network interface cards, antennas, power amplifiers, radiofrequency circuitry, transceivers, and other communication circuitry. The connections and devices may communicate over communication media to exchange communications with other computing systems or networks of systems, such as metal, glass, air, or any other suitable communication media. The aforementioned media, connections, and devices are well known and need not be discussed at length here.

Communication between computing system 601 and other computing systems (not shown), may occur over a communication network or networks and in accordance with various communication protocols, combinations of protocols, or variations thereof. Examples include intranets, internets, the Internet, local area networks, wide area networks, wireless networks, wired networks, virtual networks, software defined networks, data center buses and backplanes, or any other type of network, combination of networks, or variation thereof. The aforementioned communication networks and protocols are well known and need not be discussed at length here.

While some examples provided herein are described in the context of a neural network, deep neural network, neural network layer, or environment, it should be understood that the neural network layer configuration methods, techniques, and systems described herein are not limited to such examples and may apply to a variety of other processes, systems, applications, devices, and the like. As will be appreciated by one skilled in the art, aspects of the present invention may be embodied as a system, method, computer program product, and other configurable systems. Accordingly, aspects of the present invention may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, aspects of the present invention may take the form of a computer program product embodied in one or more computer readable medium(s) having computer readable program code embodied thereon.

Unless the context clearly requires otherwise, throughout the description and the claims, the words “comprise,” “comprising,” and the like are to be construed in an inclusive sense, as opposed to an exclusive or exhaustive sense; that is to say, in the sense of “including, but not limited to.” As used herein, the terms “connected,” “coupled,” or any variant thereof means any connection or coupling, either direct or indirect, between two or more elements; the coupling or connection between the elements can be physical, logical, or a combination thereof. Additionally, the words “herein,” “above,” “below,” and words of similar import, when used in this application, refer to this application as a whole and not to any particular portions of this application. Where the context permits, words in the above Detailed Description using the singular or plural number may also include the plural or singular number respectively. The word “or,” in reference to a list of two or more items, covers all of the following interpretations of the word: any of the items in the list, all of the items in the list, and any combination of the items in the list.

The phrases “in some examples,” “according to some examples,” “in the examples shown,” “in other examples,” and the like generally mean the particular feature, structure, or characteristic following the phrase is included in at least one implementation of the present technology, and may be included in more than one implementation. In addition, such phrases do not necessarily refer to the same example or different examples.

The above Detailed Description of examples of the technology is not intended to be exhaustive or to limit the technology to the precise form disclosed above. While specific examples for the technology are described above for illustrative purposes, various equivalent modifications are possible within the scope of the technology, as those skilled in the relevant art will recognize. For example, while processes or blocks are presented in a given order, alternative implementations may perform routines having steps, or employ systems having blocks, in a different order, and some processes or blocks may be deleted, moved, added, subdivided, combined, and/or modified to provide alternative or subcombinations. Each of these processes or blocks may be implemented in a variety of different ways. Also, while processes or blocks are at times shown as being performed in series, these processes or blocks may instead be performed or implemented in parallel or may be performed at different times. Further any specific numbers noted herein are only examples: alternative implementations may employ differing values or ranges.

The teachings of the technology provided herein can be applied to other systems, not necessarily the system described above. The elements and acts of the various examples described above can be combined to provide further implementations of the technology. Some alternative implementations of the technology may include not only additional elements to those implementations noted above, but also may include fewer elements.

These and other changes can be made to the technology in light of the above Detailed Description. While the above description describes certain examples of the technology, and describes the best mode contemplated, no matter how detailed the above appears in text, the technology can be practiced in many ways. Details of the system may vary considerably in its specific implementation, while still being encompassed by the technology disclosed herein. As noted above, particular terminology used when describing certain features or aspects of the technology should not be taken to imply that the terminology is being redefined herein to be restricted to any specific characteristics, features, or aspects of the technology with which that terminology is associated. In general, the terms used in the following claims should not be construed to limit the technology to the specific examples disclosed in the specification, unless the above Detailed Description section explicitly defines such terms. Accordingly, the actual scope of the technology encompasses not only the disclosed examples, but also all equivalent ways of practicing or implementing the technology under the claims.

To reduce the number of claims, certain aspects of the technology are presented below in certain claim forms, but the applicant contemplates the various aspects of the technology in any number of claim forms. For example, while only one aspect of the technology is recited as a computer-readable medium claim, other aspects may likewise be embodied as a computer-readable medium claim, or in other forms, such as being embodied in a means-plus-function claim. Any claims intended to be treated under 35 U.S.C. § 112(f) will begin with the words “means for” but use of the term “for” in any other context is not intended to invoke treatment under 35 U.S.C. § 112(f). Accordingly, the applicant reserves the right to pursue additional claims after filing this application to pursue such additional claim forms, in either this application or in a continuing application.

What is claimed is:

1. A method, comprising:
determining an accuracy improvement of a layer of a neural network implemented using a first bit precision relative to using a second bit precision;
determining a latency degradation of the layer of the neural network implemented using the first bit precision relative to using the second bit precision; and
selecting, based on the accuracy improvement and the latency degradation, the first bit precision or the second bit precision for use in implementing the layer of the neural network.

2. The method of claim 1, wherein the first bit precision is based on a first quantization of floating point data to fixed point data of a first length, and wherein the second bit precision is based on a second quantization of the floating point data to fixed point data of a second length that differs relative to the first length.

3. The method of claim 1, wherein determining the accuracy improvement comprises:
determining a first accuracy of the layer of the neural network when implemented using the first bit precision;
determining a second accuracy of the layer of the neural network when implemented using the second bit precision; and
calculating a difference between the first accuracy and the second accuracy.

4. The method of claim 1, wherein determining the latency degradation comprises:
determining a first latency of the layer of the neural network when implemented using the first bit precision;
determining a second latency of the layer of the neural network when implemented using the second bit precision; and
calculating a difference between the first latency and the second latency.

5. The method of claim 1, further comprising determining an impact factor of the layer based on the accuracy improvement and the latency degradation, wherein selecting the first bit precision or the second bit precision is based further on the impact factor.

6. The method of claim 1, further comprising determining a mixed precision factor for the neural network in which the layer uses the second bit precision and one or more further layers use the first bit precision, wherein selecting the first bit precision or the second bit precision is based further on a comparison between the mixed precision factor and a threshold mixed precision factor.

7. The method of claim 6, further comprising:
selecting the second bit precision for use in implementing a further layer of the neural network;
determining a further mixed precision factor for the neural network in which the layer and the further layer use the second bit precision;
comparing the further mixed precision factor and the threshold mixed precision factor; and
selecting the first bit precision for use in implementing the further layer of the neural network based on the further mixed precision factor exceeding the threshold mixed precision factor.

8. A configuration engine, comprising:
one or more computer-readable storage media;
a processing system coupled to the one or more computer-readable storage media; and
program instructions stored on the one or more computer-readable storage media that, based on being read and executed by the processing system, direct the configuration engine to:
determine an accuracy improvement of a layer of a neural network implemented using a first bit precision relative to using a second bit precision;
determine a latency degradation of the layer of the neural network implemented using the first bit precision relative to using the second bit precision; and
select, based on the accuracy improvement and the latency degradation, the first bit precision or the second bit precision for use in implementing the layer of the neural network.

9. The configuration engine of claim 8, wherein the first bit precision is based on a first quantization of floating point data to fixed point data of a first length, and wherein the second bit precision is based on a second quantization of the floating point data to fixed point data of a second length that differs relative to the first length.

10. The configuration engine of claim 8, wherein to determine the accuracy improvement, the program instructions direct the configuration engine to:
determine a first accuracy of the layer of the neural network when implemented using the first bit precision;
determine a second accuracy of the layer of the neural network when implemented using the second bit precision; and
calculate a difference between the first accuracy and the second accuracy.

11. The configuration engine of claim 8, wherein to determine the latency degradation, the program instructions direct the configuration engine to:
determine a first latency of the layer of the neural network when implemented using the first bit precision;
determine a second latency of the layer of the neural network when implemented using the second bit precision; and
calculate a difference between the first latency and the second latency.

12. The configuration engine of claim 8, wherein the program instructions further direct the configuration engine to determine an impact factor of the layer based on the accuracy improvement and the latency degradation, wherein selecting the first bit precision or the second bit precision is based further on the impact factor.

13. The configuration engine of claim 8, wherein the program instructions further direct the configuration engine to determine a mixed precision factor for the neural network in which the layer uses the second bit precision and one or more further layers use the first bit precision, wherein selecting the first bit precision or the second bit precision is based further on a comparison between the mixed precision factor and a threshold mixed precision factor.

14. The configuration engine of claim 13, wherein the program instructions further direct the configuration to:
select the second bit precision for use in implementing a further layer of the neural network;
determine a further mixed precision factor for the neural network in which the layer and the further layer use the second bit precision;
compare the further mixed precision factor and the threshold mixed precision factor; and
select the first bit precision for use in implementing the further layer of the neural network based on the further mixed precision factor exceeding the threshold mixed precision factor.

15. One or more computer-readable storage media having program instructions stored thereon, wherein the program instructions, when read and executed by a processing system, direct the processing system to:
determine an accuracy improvement of a layer of a neural network implemented using a first bit precision relative to using a second bit precision;
determine a latency degradation of the layer of the neural network implemented using the first bit precision relative to using the second bit precision; and
select, based on the accuracy improvement and the latency degradation, the first bit precision or the second bit precision for use in implementing the layer of the neural network.

16. The one or more computer-readable storage media of claim 15, wherein the first bit precision is based on a first quantization of floating point data to fixed point data of a first length, and wherein the second bit precision is based on a second quantization of the floating point data to fixed point data of a second length that differs relative to the first length.

17. The one or more computer-readable storage media of claim 15, wherein to determine the accuracy improvement, the program instructions direct the processing system to:
determine a first accuracy of the layer of the neural network when implemented using the first bit precision;
determine a second accuracy of the layer of the neural network when implemented using the second bit precision; and
calculate a difference between the first accuracy and the second accuracy.

18. The one or more computer-readable storage media of claim 15, wherein to determine the latency degradation, the program instructions direct the processing system to:
determine a first latency of the layer of the neural network when implemented using the first bit precision;
determine a second latency of the layer of the neural network when implemented using the second bit precision; and
calculate a difference between the first latency and the second latency.

19. The one or more computer-readable storage media of claim 15, wherein the program instructions further direct the processing system to determine an impact factor of the layer based on the accuracy improvement and the latency degradation, wherein selecting the first bit precision or the second bit precision is based further on the impact factor.

20. The one or more computer-readable storage media of claim 15, wherein the program instructions further direct the configuration engine to determine a mixed precision factor for the neural network in which the layer uses the second bit precision and one or more further layers use the first bit precision, wherein selecting the first bit precision or the second bit precision is based further on a comparison between the mixed precision factor and a threshold mixed precision factor.
